(19) United States
(12) Patent Application Publication
(10) Pub. No.: US 2010/0104350 A1
(43) Pub. Date: Apr. 29, 2010

(54) LED LUMINOUS PEN

(76) Inventor: Jixian Hu, Zhejiang (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/450,768

(22) PCT Filed: Mar. 26, 2008
(86) PCT No.: PCT/CN2008/000592

§ 371 Date: Oct. 13, 2009

(30) Foreign Application Priority Data
Apr. 13, 2007 (CN) 200710068049.0

(51) Int. Cl. B43K 29/00

(52) U.S. Cl. 401/195

(57) ABSTRACT

A LED luminous pen includes a penholder (1), a pen core (2), a battery (3), a luminous circuit board (4), and a LED (5). A rotary assembly (8) can move the pen core (2) up and down restrictedly and is sleeved at upper portion of the pen core (2). The penholder (1) at least includes an upper penholder portion (11) and a lower penholder portion (13), an anode of the battery (3) is electrically connected with an anode input (41) of the luminous circuit board (4), a cathode of the battery (3) is electrically connected with a conductive spring (7) through a metallic core cap of the pen core (71) and a cathode spring (72). When the pen core is in use, the strength of the core will not be transmitted to the battery, so that it can make every contact in LED luminous circuit conduct well.

### BACKGROUND OF THE PRESENT INVENTION

1. Field of Invention

The present invention relates to a writing pen with illumination device, and more particularly to a LED luminous pen using a LED (light-emitting diode) as an illumination light source.

2. Description of Related Arts

With the rapid development of LED technology in recent years, there are a lot of LED luminous pens using the LED as an illumination light source currently on the market. Because this kind of LED luminous pen has an illumination light source, ordinary pen is capable of acting as a micro-flashlight to help to write in the dark, find something, look at the watch or read the letters and so on. Luminescence components of LED are designed into a variety of colors and flashing modes in some LED luminous pens so that the luminous effects of the LED luminous pens get brighter, wining more and more favor of people. For example, two China utility model patents, “Pressing extra-soft lamp pen”, Patent No. ZL02200769.5 (Publication No. CN 2520256Y), and “Luminous pen stretching pen cap”, Patent No. ZL03253042.0 (Publication No. CN 2645929Y) disclose the luminous pen. In the above mentioned two patents, the battery, the light-emitting diode and the pen core are provided at a rear, middle and front, respectively, which has two shortcomings. Firstly, the light-emitting diode illuminates a middle area and a peripheral area thereof of a penholder, without focusing on a surrounding of a penpoint, so the decorative function of the luminous pen is more than the practical function thereof. Secondly, under space constraints, the pen core has a shorter length and less capacity of ink, it is easy to use up and needs regular replacement, so it is not practical enough.

To solve these problems, I have earlier applied for an invention patent, “LED luminous pen”, Application No. 200510107778.3 (Publication No. CN1785691A) disclosing a solution. A battery is electrically connected with a light-emitting diode by a high voltage power module comprising a boost circuit, and a pen core penetrates through a middle of the high voltage power module. Furthermore, the patent utilizes a 1.5v general column battery to make white LED light, the light-emitting diode is provided at a bottom of the penholder to collect illumination sites around the pen point. The design of the pen core penetrating through the middle of the high voltage power module makes it possible for a longer pen core to use in the LED luminous pen.

However, a top of the pen core of the above mentioned LED luminous pen directly contacts with a cathode of the battery, an anode of the battery contacts with a switch member, people write by the penpoint of the pen core in practical use, so that the penpoint is subject to an upward pressure, the upward pressure is directly transferred from the pen core to the battery, and then to the switch member provided above the battery. People apply different forces and force directions while writing, often needing to tilt. The unsure pressure easily causes the switch member to move relative to the penholder, so that the conduction between the switch member and penholder, or and a touch piece within the penholder is affected, leading to flickering luminescence of the LED while writing. At the same time, during the continuous writing, a conductive contact point between the switch member and the penholder, a contact point between the pen core and the cathode of the power supply are also worn and torn each other, easily resulting in a bad contact and affecting the normal luminescence of the LED. Sometimes, people apply an over-force while writing, or the pen core is subject to a stronger pressure if the LED luminous pen accidentally falls off, easily causing the damage of the switch member and making the LED luminous pen not work.

Moreover, the LED luminous pen uses the top of the pen core as a conductive component for conducting the cathode of the battery to the boost circuit, wherein the top of the pen core is made of metallic material, however, most of general pen cores on the market use nonmetallic shell in whole, so the applicability of the LED luminous pen is not strong.

### SUMMARY OF THE PRESENT INVENTION

A technical problem to be solved of the present invention is to provide a LED luminous pen, which is capable of ensuring a stable light-emitting, wherein during the usage, a force applied to a pen core of the LED luminous pen will not be transferred to a battery, so that each contact point of LED circuit is capable of well switching into conduction.

Accordingly, in order to accomplish the above object, the present invention provides a LED luminous pen, comprising a penholder, a pen core, a battery, a luminous circuit board, and a LED (light-emitting diode) electrically connected with the luminous circuit board, wherein the pen core, the battery, the luminous circuit board and the light-emitting diode are provided within the penholder, wherein the battery is provided at an upper portion of the penholder, the luminous circuit board and the LED are provided at a lower portion of the penholder, the pen core penetrates through a middle of the luminous circuit board, a rotary assembly is sleeved at the upper portion of the pen core and is capable of moving the pen core up and down restrictedly;

wherein the penholder comprises at least an upper penholder portion and a lower penholder portion, the lower penholder portion is made of transparent nonmetallic material, the LED is provided around a penpoint of the pen core;

wherein an anode of the battery is electrically connected with an anode of the luminous circuit board by a conductive component, a cathode of the battery is electrically connected with a conductive spring sleeved outside the pen core and inside the rotary assembly, a bottom of the conductive spring contacts with a cathode input of the luminous circuit board.

The cathode of the battery is electrically connected with the conductive spring as follows, wherein a metallic core cap is sleeved at the conductive spring and outside a top portion of the pen core, the metallic core cap is connected with the rotary assembly, a negative spring is provided between the cathode of the battery and the metallic core cap for switching into conduction.

The LED can be provided within or outside the lower penholder portion, that is to say, it is only provided around the penpoint of the pen core for luminizing around the penpoint while using the pen core.

Furthermore, it can use various existing rotary assemblies out of the pen core to achieve the pen core passing in and out of the penholder, so that when the pen core does not work, it can be retracted to the penholder for protection. The rotary assemblies can be various rotary assemblies on the market, such as normal unidirectional rotating member, Gaoshi rotating member, Pike rotating member and so on.

The conductive component of the anode of the battery and the anode input of the luminous circuit board, can be a single conductive bar provided at an inner wall of the upper penholder portion, two ends of the conductive bar contact with the anode of the battery and the anode input of the luminous circuit board, respectively for switching into conduction.

The upper penholder portion also can be used to the conductive component, transmitting positive electricity from an upper portion of the penholder to a lower portion thereof, that is to say, the upper penholder portion is made of metallic material, an upper portion of the upper penholder portion is electrically connected with the anode of the battery, a lower portion of the upper penholder portion is electrically connected with the anode of the luminous circuit board in such a manner that the upper penholder portion acts as the conductive component.

The anode of the battery can directly contact with the upper portion of the upper penholder portion to electrically connect with each other. In order to control the luminescence of the LED, a recovery spring and a button having a switch member are provided at the upper portion of the upper penholder portion, wherein a cover, adapted for position restriction, which covers the button and is capable of restrictedly moving up and down, the button has an output portion electrically connected with the upper penholder portion, the battery is provided below the button, the anode of the battery contacts with the recovery spring of the button, that is to say, the anode of the battery is indirectly electrically connected with an upper end of the upper penholder portion by the button, at the same time, the off control of LED luminescence circuit is achieve by the switch member of the button.

The upper penholder portion is connected with the anode of the luminous circuit board as follows, wherein the penholder further comprises a middle penholder portion provided between the upper penholder portion and the lower penholder portion, the middle penholder portion is made of metallic material, the anode input of the luminous circuit board contacts with the middle penholder portion, the upper penholder portion is threadedly connected with the middle penholder portion for switching into conduction.

However, the middle penholder portion can't ensure a good contact with the anode input of the luminous circuit board because of a problem of size matching. In order to ensure the LED luminizing circuit to conduct well, the upper penholder portion is connected with the anode of the luminous circuit board as follows. The penholder further comprises a middle penholder portion provided between the upper penholder portion and the lower penholder portion, a metallic connecting casing is provided between the upper penholder portion and the middle penholder portion, the anode of the luminous circuit board has an upward protruding portion, a positive spring is provided between the metallic connecting casing and the protruding portion of the anode of the luminous circuit board for switching into conduction. Accordingly, the connecting of the upper penholder portion and the middle penholder portion looks well, here, the middle penholder portion can be made of metallic or nonmetallic material.

To make the LED luminous pen look more beautiful and use more comfortably, a silica gel sleeve is sleeved outside the middle penholder portion. Furthermore, a decorative casing is provided between the silica gel sleeve and the metallic connecting casing for forming a symmetrical appearance with the metallic connecting casing.

The upper penholder portion is connected with the anode of the luminous circuit board as follows. The penholder further comprises a middle penholder portion provided between the upper penholder portion and the lower penholder portion, the middle penholder portion is made of metallic material, the anode of the luminous circuit board contacts with the middle penholder portion, the upper penholder portion is connected with the middle penholder portion by the metallic connecting casing, a lower portion of the metallic connecting casing is inserted into the middle penholder portion, an, upper portion of the metallic connecting casing is threadedly connected with the upper penholder portion. Accordingly, the middle penholder portion acts as the conductive component to transmit the positive electricity from the upper penholder to the anode input of the luminous circuit.

Simply, the battery can be button batteries connected with each other in series. To make the LED luminize by a 1.5V ordinary column battery, the LED luminous pen can be improved as follows. The battery is a column battery; the luminous circuit board comprises a high voltage power module. The column battery can be one or two connected with each other in series.

Nowadays, with the rapid development and wide application of computers, a rechargeable battery member which is capable of plugging in a USB interface have occurred, the rechargeable battery member is capable of plugging in any computer with USB interfaces for charging.

If the rechargeable battery member is applied to the LED luminous pen, the LED luminous pen needs adaptability adjustment, namely, the battery can be a rechargeable battery and comprises a USB interface, wherein an anode and cathode of the USB interface are electrically connected with the anode and cathode of the battery, an anode output of the USB interface is electrically connected with the anode input of the luminous circuit board by the conductive component, a cathode output of the USB interface is electrically connected with a conductive spring sleeved outside the pen core and inside the rotary assembly.

Here, the LED luminescence circuit does not comprise the upper penholder portion; the upper penholder portion can be made of metallic or nonmetallic material.

Simply, the anode output of the USB interface is electrically connected with the anode input of the luminous circuit board by the upper penholder portion acting as the conductive component, namely, the upper penholder portion is made of metallic material and acts as the conductive component, the anode output of the USB interface and the anode input of the luminous circuit board contact with the upper penholder portion for switching into conduction. At the time, the upper penholder portion is a conductive member of the LED luminescence circuit, so it is made of metallic material.

The anode output of the USB interface is electrically connected with the anode input of the luminous circuit board by another manner as follows. A metallic connecting casing is closely provided within the upper penholder portion, an inner wall of the metallic connecting casing contacts with the anode output of the USB interface, the anode input of the luminous circuit board has an upward protruding portion, a positive spring is provided between the metallic connecting casing and the protruding portion of the anode input of the luminous circuit board for switching into conduction. Here, the metallic connecting casing and the positive spring form the conductive component.

However, the upper penholder portion can't ensure a good contact with the anode input of the luminous circuit board because of a problem of size matching. In order to ensure the LED luminizing circuit to conduct well, the conductive component is well designed as follows. A metallic connecting casing is closely provided within the upper penholder portion, an inner wall of the metallic connecting casing has a loop spring accommodating groove, a top end of an upper positive spring provided within the loop spring accommodating groove is electrically connected with the anode output of the USB interface, an anode input of the luminous circuit board has an upward protruding portion, a lower positive spring is provided between the metallic connecting casing and the upward protruding portion of the anode input of the luminous circuit board for switching into conduction, the metallic connecting casing, the upper positive spring and the lower positive spring form the conductive component.

At the same time, an upper portion of the rotary assembly is fastened relatively to the metallic connecting casing by a rotating lining closely provided within the inner of the metallic connecting casing, a lower portion of the rotary assembly is fastened relatively to the upper penholder portion by a fastening casing closely provided within the inner of the upper penholder portion, in such a manner that, the upper portion of the rotary assembly, rotating lining and the metallic connecting casing are fastened relative to each other, the lower portion of the rotary assembly, fastening casing and the upper penholder portion are fastened relative to each other, so that the rotary assembly is driven to achieve the pen core passing in and out of the penholder by relatively rotating the metallic connecting casing and the upper penholder portion. Furthermore, it is reliable for the rotary assembly to restrictedly move within the penholder.

Compared with the prior art, the present invention has the following advantages. The conductive spring and the metallic core cap, negative spring provided above the conductive spring, which are provided between the cathode of the battery and the luminous circuit board, have changed the technology of existing LED luminous pen that the pen core, as a part of conductive circuit, must be directly contact with the cathode of the battery, in such a manner that, no matter how the pen core rotates and tilts, a force applied to the pen core will be transmitted to the metallic core cap without being transmitted to the battery and other parts provided above the battery, so that the problem of LED flicker caused by indefinite writing intensity is thoroughly solved. Furthermore, the negative spring can always ensure the electrical connection with the cathode of the battery for ensuring the luminescence circuit to conduct well. The anode of the battery is communicated with the upper penholder portion by the button having a switch member, the cathode of the battery is communicated with the LED by the negative spring, metallic core cap, conductive spring and luminous circuit board, in such a manner that, LED is controlled to luminize by the button having the switch member, the pen core is controlled to retract within the penholder by the rotary assembly. Furthermore, the pen core of the present invention does not join the luminescence circuit, so it is unnecessary for a casing of the pen core to adopt the conductive material. Accordingly, the current pen cores on the market are all adapted for the LED luminous pen, increasing the applicability of the LED luminous pen. At the same time, in the present invention, besides the button battery and normal column battery, the battery which is capable of plugging in the USB interface also can be a power supply for LED, which is a great breakthrough in the field of LED luminous pen.

### BRIEF DESCRIPTION OF THE DRAWINGS

FIG. 1 is a perspective view of a LED luminous pen according to a first preferred embodiment of the present invention.

FIG. 2 is a partial enlargement view of I portion shown in FIG. 1.

FIG. 3 is a general assembly view of the above first preferred embodiment of the present invention.

FIG. 4 is a perspective view of a LED luminous pen according to a second preferred embodiment of the present invention.

FIG. 5 is a perspective view of a LED luminous pen according to a third preferred embodiment of the present invention.

FIG. 6 is a perspective view of a LED luminous pen according to a fourth preferred embodiment of the present invention.

FIG. 7 is a partial enlargement view of the II portion shown in FIG. 6.

FIG. 8 is a partial enlargement view of the III portion shown in FIG. 6.

FIG. 9 is a general assembly view of the above fourth preferred embodiment of the present invention.

FIG. 10 is a perspective view of a LED luminous pen according to a fifth preferred embodiment of the present invention.

### DETAILED DESCRIPTION OF THE PREFERRED EMBODIMENT

Further detailed descriptions of the present invention are illustrated as follows, combining the drawings and embodiments.

### Embodiment 1

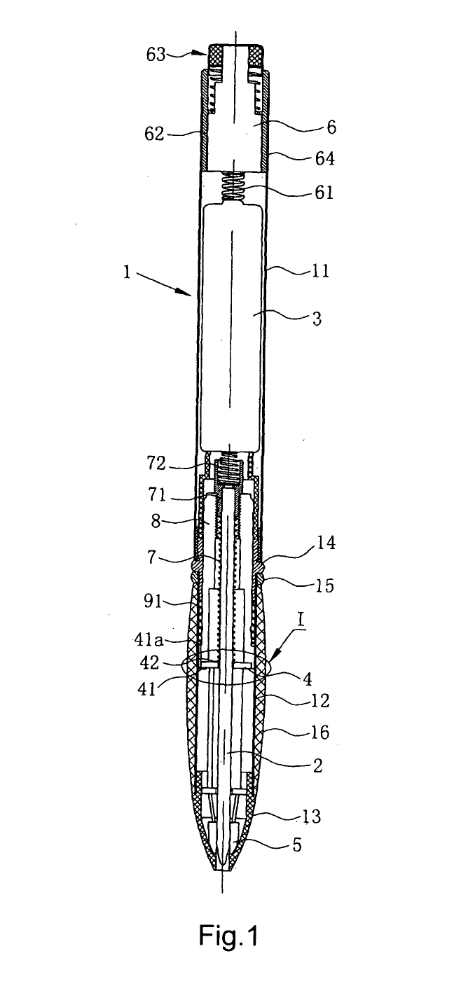

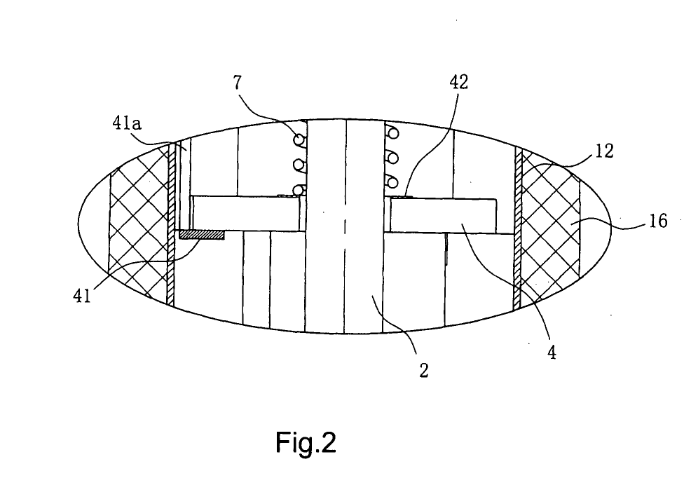

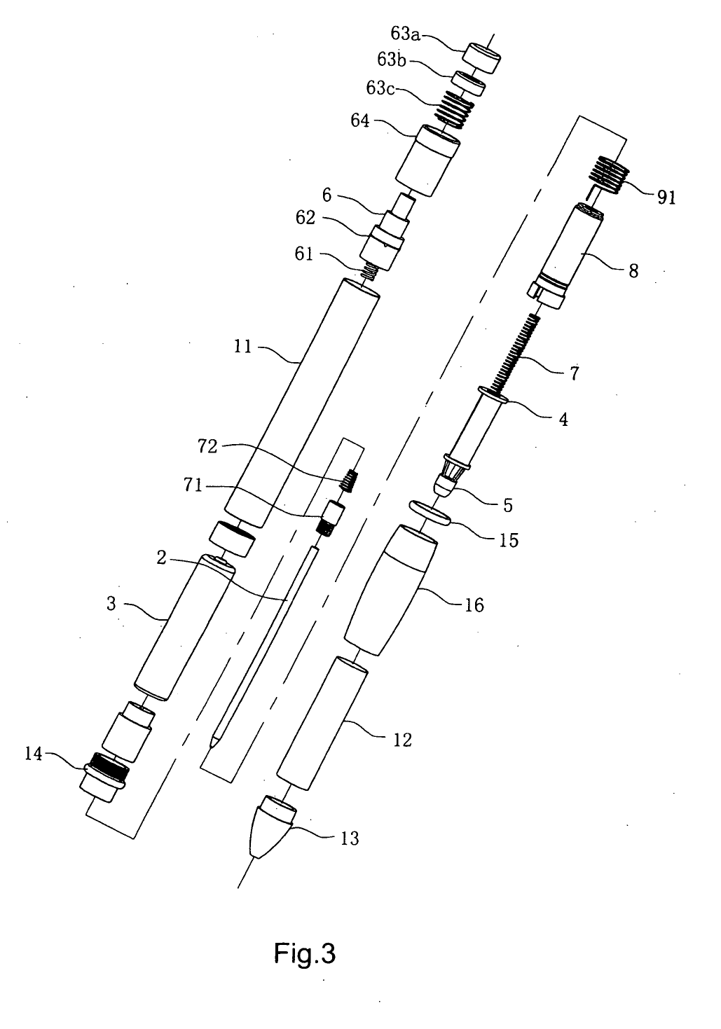

Referring to FIGS. 1 to 3 of the drawings, a LED luminous pen using a column battery as a power supply according to a first preferred embodiment of the present invention is illustrated, in which the LED luminous pen comprises a penholder 1, a pen core 2, a battery 3, a luminous circuit board 4, and a LED (light-emitting diode) 5 electrically connected with the luminous circuit board 4, wherein the pen core 2, the battery 3, the luminous circuit board 4 and the light-emitting diode 5 are provided within the penholder 1.

In the first embodiment, the battery 3 is a column battery; the luminous circuit board 4 comprises a high voltage power module, so that the LED 5 is capable of luminizing by an ordinary 1.5V column battery.

The penholder 1 comprises an upper penholder portion 11, a middle penholder portion 12 and a lower penholder portion 13, the upper penholder portion 11, the middle penholder portion 12 and the lower penholder portion 13 are connected with each other to a whole from up to down in turn. The battery 3 is provided within the upper penholder portion 11, namely, an upper portion of the penholder 1. The luminous circuit board 4 and the LED 5 are provided at a lower portion of the penholder 1, the lower penholder portion 13 is made of transparent nonmetallic material, the LED 5 is provided within the lower penholder portion 13, the pen core 2 penetrates through a middle of the luminous circuit board 4, the middle penholder portion 12 can be made of metallic or nonmetallic material.

The upper penholder portion 11 is made of metallic material, an upper end of the upper penholder portion 11 is electrically connected with an anode of the battery 3, a lower end of the upper penholder portion 11 is electrically connected with an anode input 41 of the luminous circuit board 4 for acting as a conductive component, in such a manner that, the anode of the battery 3 is electrically connected with the anode input 41 of the luminous circuit board 4 by the conductive component, namely the upper penholder portion 11.

The upper end of the upper penholder portion 11 is electrically connected with the anode of the battery 3 as follows. A recovery spring 61 and a button 6 having a switch member are provided at an upper portion of the upper penholder portion 11, a cover 63, adapted for position restriction, which covers the button 6 and is capable of restrictedly moving up and down. In the first embodiment, the cover 63 is composed of a cap casing 63a, a cap lining 63b and a cap spring 63c. The button 6 has an output portion 62 electrically connected with the upper penholder portion 11, in the first embodiment, a metallic top casing 64 is provided between the upper penholder portion 11 and the output portion 62 of the button 6. The battery 3 is provided below the button 6, the anode of the battery 3 contacts with the recovery spring 61 of the button 6, that is to say, the anode of the battery 3 is indirectly electrically connected with the upper end of the upper penholder portion 11 by the button 6 and the metallic top casing 64.

The upper penholder portion 11 is connected with the anode input 41 of the luminous circuit board 4 as follows. A metallic connecting casing 14 is provided between the upper penholder portion 11 and the middle penholder portion 12. The anode input 41 of the luminous circuit board 4 has an upward protruding portion 41a, a positive spring 91 is provided between the metallic connecting casing 14 and the protruding portion 41a of the anode input 41 of the luminous circuit board 4 for switching into conduction.

In order to look more beautiful, a silica gel sleeve 16 is sleeved outside the middle penholder portion 12. A decorative casing 15 is provided between the silica gel sleeve 16 and the metallic connecting casing 14 for forming an symmetrical appearance with the metallic connecting casing 14.

At the same time, the cathode of the battery 3 is electrically connected with a conductive spring 7 sleeved outside the pen core 2, a bottom of the conductive spring 7 contacts with a cathode input 42 of the luminous circuit board 4, so that the cathode of the battery 3 is electrically connected with the cathode input 42 of the luminous circuit board 4.

Furthermore, a rotary assembly 8 is sleeved outside the upper portion of the pen core 2 out of the conductive spring 7, which is capable of moving restrictedly up and down the pen core 2. In the first embodiment, the rotary assembly 8 adopts the Gaoshi rotating member to achieve the pen core 2 passing in and out of the penholder 1.

The cathode of the battery 3 is electrically connected with the conductive spring 7 sleeved outside the pen core 2 as follows. A metallic core cap 71, provided above the conductive spring 7 and out of a top of the pen core 2, is connected with a top of the rotary assembly 8. A negative spring 72 is provided between the cathode of the battery 3 and the metallic core cap 71 for switching into conduction.

Pressing the cover 63 and the button 6 while using, the switch member provided within the button 6 switches into conduction, the LED 5 gains electric and luminizes, specific pathway is illustrated as follows: the anode of the battery 3→the output portion 62 of the button 6→the metallic top casing 64→the upper penholder portion 11→the metallic connecting casing 14→the positive spring 91→the anode input 41 of the luminous circuit board 4→the LED 5→the cathode input 42 of the luminous circuit board 4→the conductive spring 7→the metallic core cap 71→the negative spring 72→the cathode of the battery 3.

Pressing the button 6 again, the switch member provided within the button 6 is turned off, so that the LED 5 goes out because of power loss.

### Embodiment 2

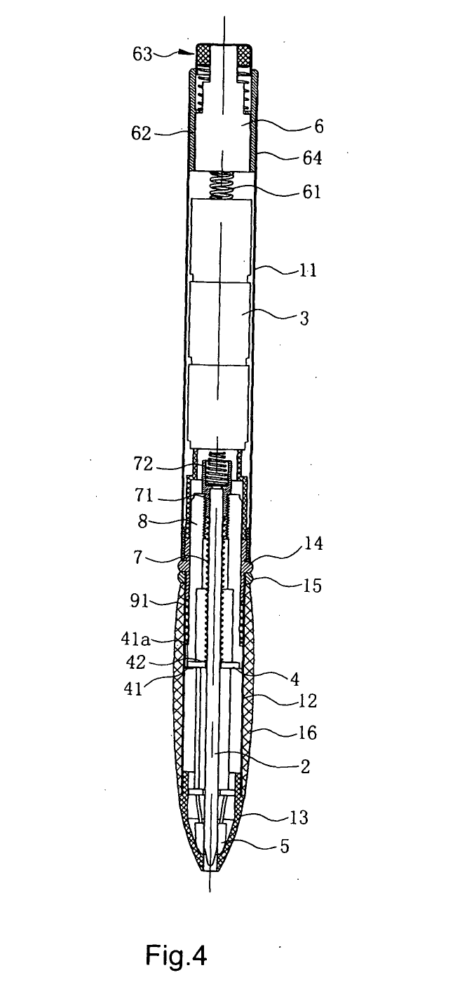

FIG. 4 is a second preferred embodiment of the present invention. Compared with the first preferred embodiment, the difference is that the battery 3 is composed of three button batteries connected with each other in series, the luminous circuit board 4 does not need the high voltage power module.

### Embodiment 3

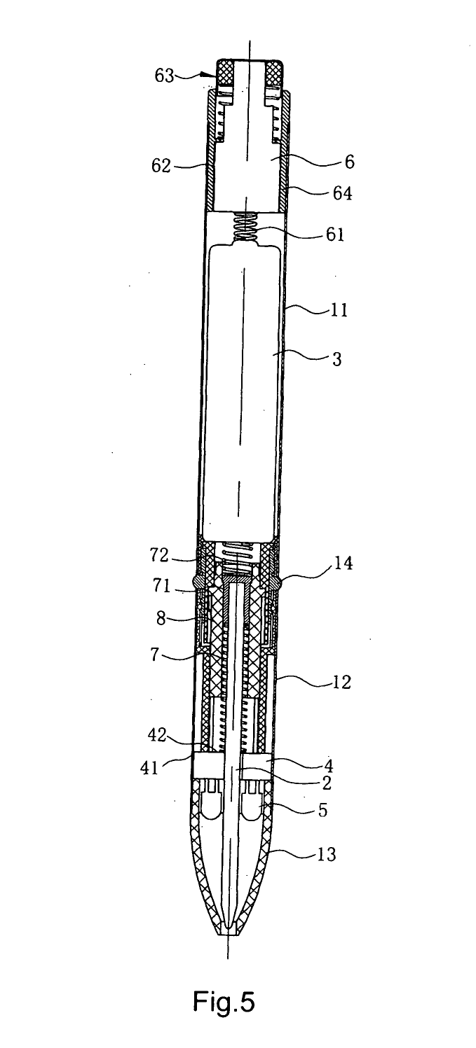

FIG. 5 is a third preferred embodiment of the present invention, compared with the first preferred embodiment, the difference is that the rotary assembly 8 adopts a single direction rotating member to achieve the pen core 2 passing in and out of the penholder 1. Because the single direction rotating member and Gaoshi rotating member have different structure and shape, the luminous circuit board 4 of the LED luminous pen and the shape of the LED 5 are slightly different, the structure of the metallic core cap 71 is different.

In the third embodiment, the middle penholder portion 12, made of metallic material, joins the LED circuit. The upper penholder portion 11 is electrically connected with the anode input 41 of the luminous circuit board 4 as follows. The anode input 41 of the luminous circuit board 4 contacts with the middle penholder portion 12, the upper penholder portion 11 contacts with the middle penholder portion 12 by a metallic connecting casing 14, a bottom of the metallic connecting casing 14 is inserted into the middle penholder portion 12, an upper of the metallic connecting casing 14 is threadedly connected with the upper penholder portion 11.

The specific pathway is illustrated as follows: the anode of the battery 3→the output portion 62 of the button 6→the metallic top casing 64→the upper penholder portion 11→the metallic connecting casing 14→the middle penholder portion 12→the anode input 41 of the luminous circuit board 4→the LED 5→the cathode input 42 of the luminous circuit board 4→the conductive spring 7→the metallic core cap 71→the negative spring 72→the cathode of the battery 3.

### Embodiment 4

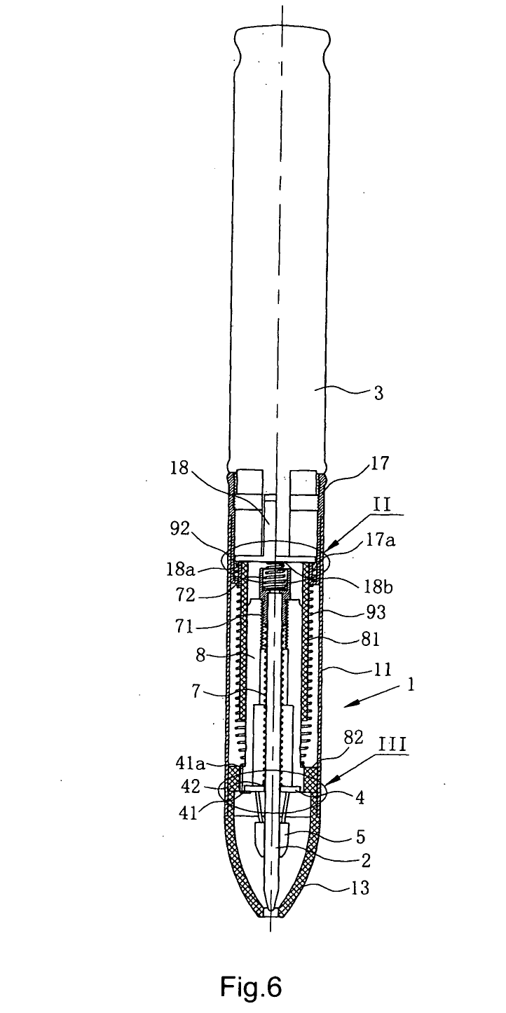

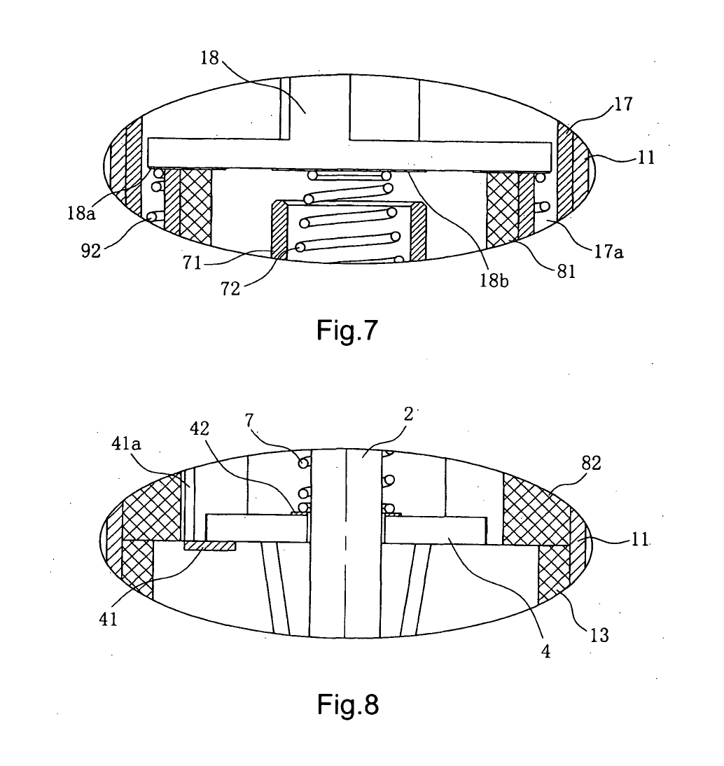

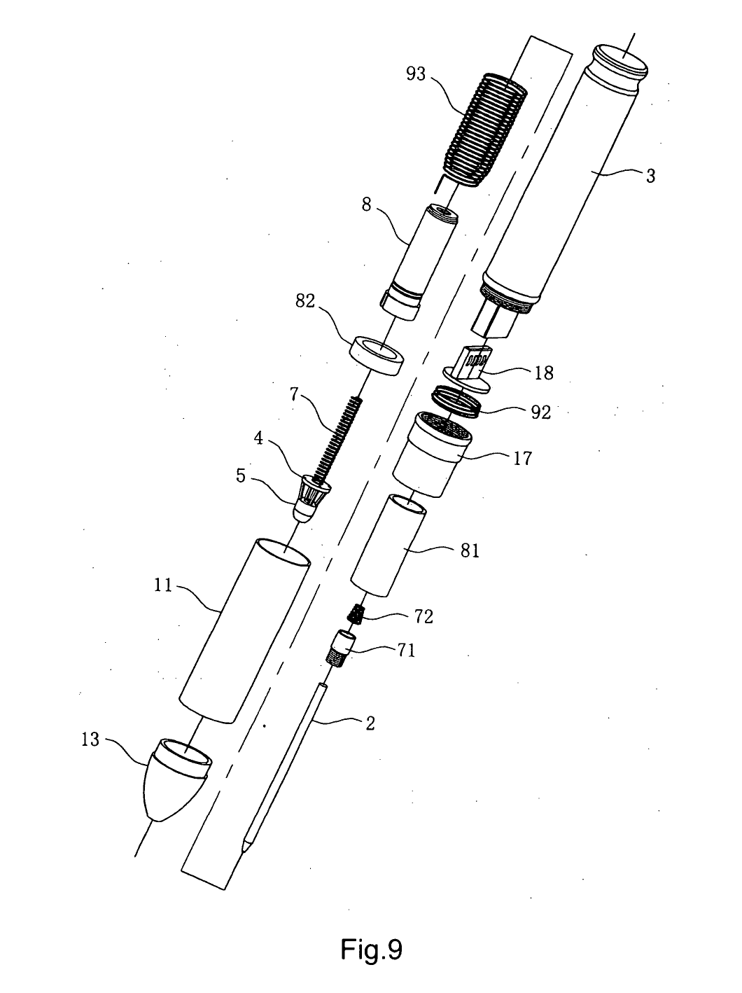

Referring to FIGS. 6 to 9, a LED luminous pen using a rechargeable battery as a power supply according to a fourth preferred embodiment of the present invention is illustrated, in which the LED luminous pen comprises a penholder 1, a pen core 2, a battery 3, a luminous circuit board 4, and a LED (light-emitting diode) 5 electrically connected with the luminous circuit board 4, wherein the pen core 2, the battery 3, the luminous circuit board 4 and the light-emitting diode 5 are provided within the penholder 1.

An upper penholder portion 11 and a lower penholder portion 13 are connected each other to form a whole, namely, the penholder 1. The upper penholder portion 11 can be made of metallic or nonmetallic material. The battery 3 is provided above a top of the upper penholder portion 11. The luminous 4 and the LED 5 are provided at a lower portion of the penholder 1. The lower penholder portion 13 is made of transparent nonmetallic material. The LED 5 is provided within the lower penholder portion 13; the pen core 2 penetrates through a middle of the luminous circuit board 4.

In the present invention, the battery 3 is a rechargeable battery. Furthermore, a USB interface 18 is provided at a top of the upper penholder portion 11, an anode and cathode of the USB interface 18 are electrically connected with an anode and cathode of the battery 3, an anode output 18a of the USB interface 18 is electrically connected with an anode input 41 of the luminous circuit board 4 by a conductive component, a cathode output 18b of the USB interface 18 is electrically connected with a conductive spring 7 sleevedly provided out of the pen core 2, a bottom of the conductive spring 7 contacts with a cathode input 42 of the luminous circuit board 4.

The anode output 18a of the USB interface 18 is electrically connected with the anode input 41 of the luminous circuit board 4 as follows. A metallic connecting casing 17 is provided within the upper penholder portion 11, an inner wall of the metallic connecting casing 17 has a loop spring accommodating groove 17a. A top end of an upper positive spring 92 provided within the loop spring accommodating groove 17a is electrically connected with the anode output 18a of the USB interface 18. An anode input 41 of the luminous circuit board 4 has an upward protruding portion 41a, a lower positive spring 93 is provided between the metallic connecting casing 17 and the upward protruding portion 41a of the anode input 41 of the luminous circuit board 4 for switching into conduction. The metallic connecting casing 17, the upper positive spring 92 and the lower positive spring 93 form the conductive component.

Furthermore, a rotary assembly 8 is sleevedly provided out of the upper portion of the pen core 2 out of the conductive spring 7, which is capable of moving restrictedly up and down the pen core 2. An upper portion of the rotary assembly 8 is fastened relatively to the metallic connecting casing 17 by a rotating lining 81 closely provided within the inner of the metallic connecting casing 17, a lower portion of the rotary assembly 8 is fastened relatively to the upper penholder portion 11 by a fastening casing 82 closely provided within the inner of the upper penholder portion 11. In the first embodiment, the rotary assembly 8 adopts the Gaoshi rotating member.

The cathode output 18b of the USB interface 18 is electrically connected with the conductive spring 7 sleevedly provided out of the pen core 2 as follows. A metallic-core cap 71 is provided at the conductive spring 7, out of the top of the pen core 2, the metallic core cap 71 is connected with a top of the rotary assembly 8. Moreover, a negative spring 72 is provided between the cathode output 18b of the USB interface 18 and the metallic core cap 71 for switching into conduction.

Plugging in the battery 3 while using, the LED 5 gains electric and luminizes, the specific pathway is illustrated as follows: the anode output 18a of the USB interface 18→the upper positive spring 92→the metallic connecting casing 17→the lower positive spring 93→the anode input 41 of the luminous circuit board 4→the LED 5→the cathode input 42 of the luminous circuit board 4→the conductive spring 7→the metallic core cap 71→the negative spring 72→the cathode output 18b of the USB interface 18.

### Embodiment 5

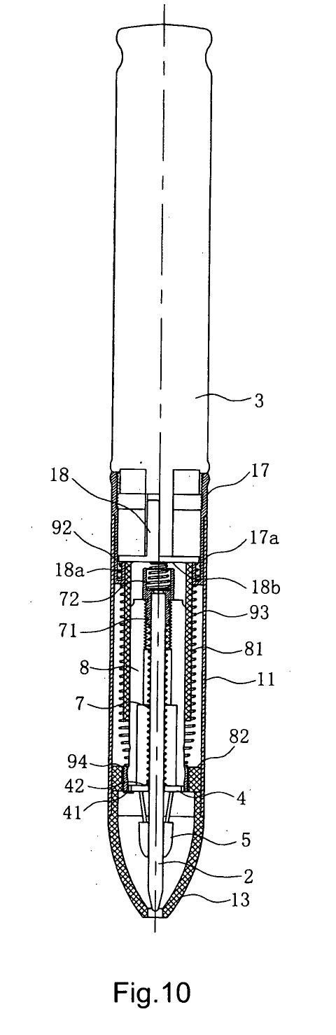

FIG. 10 is a fifth embodiment of the present invention, compared with the first preferred embodiment, the difference is that the rotary assembly 8 adopts Pike rotating member to achieve the pen core 2 passing in and out of the penholder 1.

What is claimed is:

1. A LED luminous pen, comprising:
a penholder (1), a pen core (2), a battery (3), a luminous circuit board (4), and a LED (light-emitting diode) (5) electrically connected with said luminous circuit board (4), wherein said pen core (2), said battery (3), said luminous circuit board (4) and said light-emitting diode (5) are provided within said penholder (1), wherein said battery (3) is provided at an upper portion of said penholder (1), said luminous circuit board (4) and said LED (5) are provided at a lower portion of said penholder (1), said pen core (2) penetrates through a middle of said luminous circuit board (4), a rotary assembly (8) is sleeved at said upper portion of said pen core (2) and is capable of moving said pen core (2) up and down restrictedly,
wherein said penholder (1) comprises at least an upper penholder portion (11) and a lower penholder portion (13), said lower penholder portion (13) is made of transparent nonmetallic material, said LED (5) is provided around a penpoint of said pen core (2),
wherein an anode of said battery (3) is electrically connected with an anode input (41) of said luminous circuit board (4) by a conductive component, a cathode of said battery (3) is electrically connected with a conductive spring (7) sleeved outside said pen core (2) and inside said rotary assembly (8), a bottom of said conductive spring (7) contacts with a cathode input (42) of said luminous circuit board (4),
wherein said cathode of said battery (3) is electrically connected with said conductive spring (7) as follows, wherein a metallic core cap (71) is sleeved at said conductive spring (7) and outside a top portion of said pen core (2), said metallic core cap (71) is connected with said rotary assembly (8), a negative spring (72) is provided between said cathode of said battery (3) and said metallic core cap (71) for switching into conduction.

2. The LED luminous pen, as recited in claim 1, wherein said a top of upper penholder portion (11) is made of metallic material, an upper portion of said upper penholder portion (11) is electrically connected with said anode of said battery (3), a lower portion of said upper penholder portion (11) is electrically connected with said anode (41) of said luminous circuit board (4) in such a manner that said upper penholder portion (11) acts as said conductive component.

3. The LED luminous pen, as recited in claim 2, wherein a recovery spring (61) and a button (6) having a switch member are provided at said upper portion of said upper penholder portion (11), wherein a cover (63), adapted for position restriction, which covers said button (6) and is capable of restrictedly moving up and down, said button (6) has an output portion (62) electrically connected with said upper penholder portion (11), said battery (3) is provided below said button (6), said anode of said battery (3) contacts with said recovery spring (61) of said button (6), namely, said anode of said battery (3) is indirectly electrically connected with an upper end of said upper penholder portion 11 by said button 6.

4. The LED luminous pen, as recited in claim 2, wherein said upper penholder portion (11) is connected with said anode input (41) of said luminous circuit board (4) as follows, wherein said penholder (1) further comprises a middle penholder portion (12) provided between said upper penholder portion (11) and said lower penholder portion (13), a metallic connecting casing (14) is provided between said upper penholder portion (11) and said middle penholder portion (12), said anode input (41) of said luminous circuit board (4) has an upward protruding portion (41a), a positive spring (91) is provided between said metallic connecting casing (14) and said protruding portion (41a) of said anode input (41) of said luminous circuit board (4) for switching into conduction.

5. The LED luminous pen, as recited in claim 2, wherein said upper penholder portion (11) is connected with said anode input (41) of said luminous circuit board (4) as follows, wherein said penholder (1) further comprises a middle penholder portion (12) provided between said upper penholder portion (11) and said lower penholder portion (13), said middle penholder portion (12) is made of metallic material, said anode input (41) of said luminous circuit board (4) contacts with said middle penholder portion (12), said upper penholder portion (11) is connected with said middle penholder portion (12) by said metallic connecting casing (14), a lower portion of said metallic connecting casing (14) is inserted into said middle penholder portion (12), an upper portion of said metallic connecting casing (14) is threadedly connected with said upper penholder portion (11).

6. The LED luminous pen, as recited in any one of claims 1 to 5, wherein said battery (3) is a column battery, said luminous circuit board (4) comprises a high voltage power module.

7. The LED luminous pen, as recited in claim 1, further comprising a USB interface (18), wherein said battery (3) is a rechargeable battery, an anode and cathode of said USB interface (18) are electrically connected with said anode and cathode of said battery (3), an anode output (18a) of said USB interface 18 is electrically connected with said anode input (41) of said luminous circuit board (4) by said conductive component, a cathode output (18b) of said USB interface (18) is electrically connected with a conductive spring (7) sleevedly outside said pen core (2) and inside said rotary assembly (8).

8. The LED luminous pen, as recited in claim 7, wherein a metallic connecting casing (17) is closely provided within said upper penholder portion (11), an inner wall of said metallic connecting casing (17) has a loop spring accommodating groove (17a), a top end of an upper positive spring (92) provided within said loop spring accommodating groove (17a) is electrically connected with said anode output (18a) of said USB interface (18), said anode input (41) of said luminous circuit board (4) has an upward protruding portion (41a), a lower positive spring (93) is provided between said metallic connecting casing (17) and said upward protruding portion (41a) of said anode input (41) of said luminous circuit board (4) for switching into conduction, said metallic connecting casing (17), said upper positive spring (92) and said lower positive spring (93) form said conductive component.

9. The LED luminous pen, as recited in claim 8, wherein an upper portion of said rotary assembly (8) is fastened relatively to said metallic connecting casing (18) by a rotating lining (81) closely provided within said inner of said metallic connecting casing (17), a lower portion of said rotary assembly (8) is fastened relatively to said upper penholder portion (11) by a fastening casing (82) closely provided within said inner of said upper penholder portion (11).
